(19) United States
(12) Patent Application Publication
(10) Pub. No.: US 2018/0238765 A1
(43) Pub. Date: Aug. 23, 2018

(54) METHOD AND SYSTEM FOR WATER METERING AND UNUSUAL WATER FLOW DETECTION

(71) Applicant: Max H. GRAMESPACHER, Seaside, CA (US)

(72) Inventor: Max H. GRAMESPACHER, Seaside, CA (US)

(21) Appl. No.: 15/885,822

(22) Filed: Feb. 1, 2018

Related U.S. Application Data
(60) Provisional application No. 62/462,157, filed on Feb. 22, 2017.

(51) Int. Cl. G01M 3/28; G01F 1/34; G01F 1/66

(52) U.S. Cl. CPC G01M 3/2815; G01F 1/66; G01F 1/34

(57) ABSTRACT

A system for detecting water flow in a pipe is provided. The system includes a sensor module comprising one or more sensors and a water flow computing system in operative communication with the sensor module. The sensor module generates one or more electrical signals at predefined intervals by sensing one or more flow parameters associated with water in the pipe. The water flow computing system is configured to receive the one or more electrical signals generated at the predefined intervals from the sensor module. The water flow computing system converts the one or more electrical signals into sensor data corresponding to the one or more flow parameters associated with water passing through the pipe. The water flow computing system further detects an unusual water flow in the pipe by comparing the sensor data against pre-defined thresholds.

### TECHNICAL FIELD

The present disclosure relates to water meters and, more particularly, to methods and systems for detecting water flow in a household water pipe system including any unusual water flow.

### BACKGROUND

A water-meter is a device for measuring and registering the quantity of water that passes through a pipe or other outlets. Conventional water meters are used to measure the volume of water used by residential and commercial buildings that are supplied by a public water supply system. Water meters provide the means to charge fees according to the volume of water delivered, and to regulate water use via tariffs.

Conventional household pipes/house lines have water meters installed at junctions between a main supply line from the water supplier and the house line. In such cases, water that goes through the main supply line to the house line is tracked and metered. One such existing system 100 is shown in FIG. 1 (prior art). Water 102 is provided by a main supply line (not shown). A valve and water meter 104 is installed before the house line to track water 106 that enters the house line. The water meter 104 can be a traditional volume meter/sensor, as an example. The system 100 includes a pressure regulator 108 that protects a device 110 (for example, any water accessing device that uses water) from pressure spikes and limits the water pressure to a freely definable limit, for example, 50 pounds per square inch (PSI). Water 112, coming out of the pressure regulator 108, is accessed via the device 110 and other such devices.

However, the conventional system only enables water metering by taking the difference between a current reading and previous readings. Traditional water meters are not equipped to detect water leakages. In addition, the water meter is, in most cases, installed below a surface in a concrete box which makes it hard to read. Furthermore, the valve and water meter 104 is installed, owned and operated by the water-supplier, and an end-user has only limited access to it. In such cases, and especially when the meter 104 is installed below walkways, access to the meter 104 for the end user becomes difficult.

Therefore, there is a need for techniques for water metering where water meter is easy to access for the users, and which provides other information such as including but not limited to water leak detection in house lines.

### SUMMARY

Various embodiments of the present disclosure provide systems and methods for detecting water flow related conditions such as usual water flow, water leakage detection, no-flow condition, or any unusual water flow conditions, etc., in a pipe by using one or more sensors and electronic processing systems.

An embodiment provides a system for detecting water flow (including any usual or unusual water flow conditions) in a pipe. Herein, the unusual water flow may refer to any scenario such as, including but not limited to, water leakage in water accessing devices (e.g., taps) or pipes, open tap, continuous flow, no-flow or any kind of faulty water accessing devices or water supply lines within house. The system includes a sensor module comprising one or more sensors and a water flow computing system in operative communication with the sensor module. The sensor module is at least partially configured in the pipe, and the sensor module is configured to generate one or more electrical signals at predefined intervals by sensing one or more flow parameters associated with water in the pipe. The water flow computing system is configured to receive the one or more electrical signals from the sensor module on a continuous basis. The water flow computing system converts the one or more electrical signals into sensor data corresponding to the one or more flow parameters associated with water passing through the pipe. The water flow computing system further detects an unusual water flow in the pipe by comparing the sensor data against pre-defined thresholds.

Another embodiment provides a water flow computing system for detecting water flow in a pipe. The water flow computing system includes a memory for storing instructions and a processor in operative communication with the memory. The processor is configured to execute the instructions and cause the water flow computing system to receive the one or more electrical signals from a sensor module at least partially configured within the pipe. The water flow computing system is further caused to convert the one or more electrical signals into sensor data corresponding to the one or more flow parameters associated with water passing through the pipe. The water flow computing system is caused to detect an unusual water flow in the pipe by comparing the sensor data against pre-defined thresholds.

Another embodiment provides a method for detecting water flow in a pipe. The method includes receiving one or more electrical signals generated at predefined intervals from a sensor module at least partially configured in the pipe. The method further includes converting the one or more electrical signals into sensor data corresponding to the one or more flow parameters associated with water passing through the pipe. The method also includes detecting an unusual water flow in the pipe by comparing the sensor data against pre-defined thresholds. The method includes sending notifications to alert a user of the unusual water flow, where the notifications is sent to a user device associated with the user.

### BRIEF DESCRIPTION OF THE FIGURES

For a more complete understanding of example embodiments of the present technology, reference is now made to the following descriptions taken in connection with the accompanying drawings in which:

FIG. 1 is a water meter system, according to prior art;

FIG. 2 is an environment where a system for detecting water flow in a pipe is deployed, in accordance with an example embodiment of the present disclosure;

FIG. 3 illustrates the system of FIG. 2, wherein a pressure sensor/sensor module is implemented for detecting water flow in a pipe, in accordance with an example embodiment of the present disclosure;

FIG. 4 illustrates the system of FIG. 2, wherein a volume and time sensor/sensor module is implemented for detecting water flow in a pipe, in accordance with an example embodiment of the present disclosure;

FIG. 5 illustrates the system of FIG. 2, wherein a vibration and sound sensor/sensor module is implemented for detecting water flow in a pipe, in accordance with an example embodiment of the present disclosure;

FIG. 6 illustrates the system of FIG. 2, wherein a combination of the pressure sensor, the volume and time sensor and the vibration and sound sensor is implemented for detecting water flow in a pipe, in accordance with an example embodiment of the present disclosure;

FIG. 7 is an example representation of records of flow periods, in accordance with an example embodiment;

FIG. 8 illustrates a data storage and acquisition module which is a part of a water flow computing system, in accordance with an example embodiment of the present disclosure;

FIG. 9 illustrates a method performed by a water-leak detection module of the water flow computing system, in accordance with an example embodiment of the present disclosure;

FIG. 10 illustrates a method performed by a notification module of the water flow computing system, in accordance with an example embodiment of the present disclosure;

FIG. 11 illustrates various modules of the water flow computing system, in accordance with an example embodiment of the present disclosure;

FIG. 12 illustrates a simplified block diagram of the water flow computing system, in accordance with an example embodiment of the present disclosure;

FIG. 13 illustrates a simplified block diagram of a user device or a client, in accordance with an example embodiment of the present disclosure; and

FIG. 14 illustrates a method for detecting water flow in a pipe, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments provide a method and a system for computing flow periods of all water flow and detecting unusual water flow in a pipe (i.e. water pipe or house line) installed at houses and apartments by implementing one or more sensors along the pipe. Analysis of all water flow enables detecting unusual flow periods caused due to leaks/leakages in the pipe or other flow related conditions that may be of interest to the users.

Water received from a main water supply line passes through a house line or a water pipe installed at a house or an apartment. A sensor module, among other electronics, is placed at one or more locations along a path of the water pipe. The sensor module can be configured at least partially within the pipe. The sensor module includes one or more sensors. Examples of the sensors include, but are not limited to, a vibration and sound sensor, a pressure sensor, and a volume and time sensor. The sensor module generates electrical signals (raw data) at pre-defined intervals (e.g. milliseconds) and sends the electrical signals to a water flow computing system on a continuous basis. The electrical signals correspond to flow parameters, such as flow volume, pressure and vibration and sound associated with water flowing in the pipe. The water flow computing system includes various elements for processing the signals received from the sensor module. Examples of the water flow computing system include, but are not limited to, a computer board, any server or device, or user device within a local area network (LAN). The electrical signals are pre-processed, for example by running the signals through filters, amplifiers, analog-to-digital converters etc. The electrical signals are converted into sensor data (digital values of the electrical signals). The sensor data is then appended with a corresponding identifier (ID) and is further processed. Further processing of the sensor data includes logically validating the sensor data by filtering out/discarding erroneous values. Time-stamps are added to the validated sensor data and the time-stamped sensor data is stored in a file for long-term storage and for future reference. The validated sensor data may be indicative of water consumption/usage, unusual water flow, no flow or usual water flow. Based on the sensor data, existence of leakage or any kind of unusual water flow may be detected.

The stored sensor data is accessed and analyzed in one or more batches, and its values are checked against pre-defined thresholds (for example, the usual range of values for flow parameters, or values associated with a usual water flow pattern) to determine a potential water leakage and/or other unusual water conditions. For example, if any flow parameter, such as the volume or the flow period exceeds respective pre-defined thresholds, then water leakage is detected. Upon detecting leakage, notifications are sent to a user at a user device associated with the user. The pre-defined thresholds are user configurable and can be customized at any instant of time.

In some embodiments, the sensor data stored in the file is also accessible to the user via applications such as a web or mobile application. The user can run the reports using these applications. Based on the report parameters, data is fetched from the storage and reports are generated and provided to the user. The report interface or tool enables report generation for any current or past period of time, which makes the system an effective tool to check the water-bill and to control or adjust the water usage with a goal to reduce water usage. For example, if the water-flow in time-wise or volume-wise manner exceeds set limits, the external alarming process is triggered, and the user is notified in these applications.

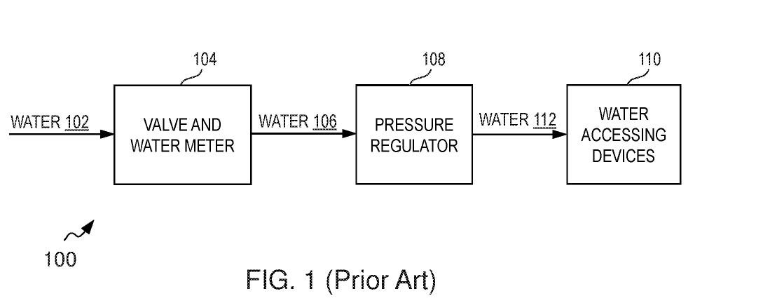

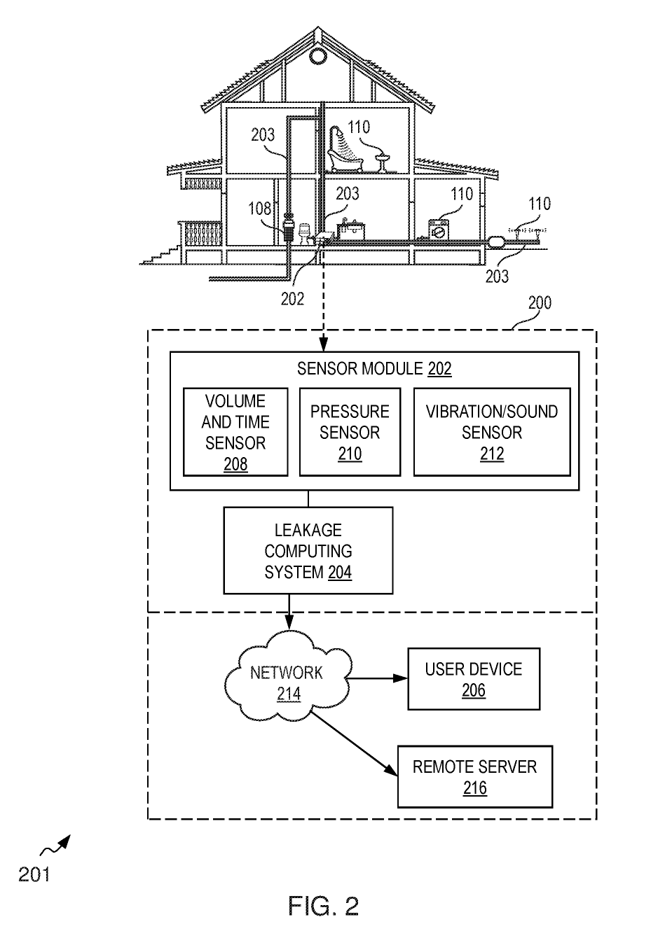

FIG. 2 illustrates an environment 201 where a system 200 for detecting unusual water flow in a pipe 203 (or house line 203) is deployed. It shall be noted that the system 200 computes flow periods of all water flow in the pipe 203 and thereby detect any unusual water flow in the pipe 203. The pipe 203 as seen in FIG. 2 carries the water 112 coming out of the pressure regulator 108 and accessed via the device 110 and other such devices as depicted in FIG. 1 (prior art) and FIG. 2. The pipe 203 has at least one inlet for receiving water from a supply line (not shown) which is controlled by a pressure-regulator (not shown in FIG. 2). As seen in FIG. 2, the pipe 203 leads the water to many different outlets, which are controlled by manual or by machine operated valves, for releasing water through various water accessing devices. Examples of the water accessing devices include, but are not limited to, taps, showers, faucets, sprinklers, washers, etc., for use by a user. It shall be noted that all water accessing devices 110 should be behind a pressure regulator and connected via a stop valve to allow water 112 pass through the pipe 203.

The system 200 includes a sensor module 202 and a water flow computing system 204. In the environment, a user device 206 is also shown that is communicably coupled to the water flow computing system 204. The sensor module 202 may have one or more sensors, and some of these sensors may be at least partially installed within the pipe 203. The sensor module 202 can include, among other electronics, one or more sensors including, but not limited to, a volume and time sensor 208, a pressure sensor 210 and a vibration and sound sensor 212. In some embodiments, the sensor module 202 can also include any traditional water volume meter (e.g., pulse meter) in addition to the sensors 208, 210 and/or 212. The traditional water volume meter is not shown in the sensor module 202, however it should be understood that the electrical signals generated from the traditional water volume meter can also be analyzed in the same manner, as explained for the electrical signals generated from the sensors 208, 210 and/or 212, in the present disclosure.

The sensor module 202 is in operative communication with the water flow computing system 204. In some embodiments, the sensor module 202 is coupled to the water flow computing system 204 through wired means, such as a two or three-string wire, a twisted cable, co-axial cable, etc. The sensor module 202 can be connected to an electronic board (not shown) through wired means, which further connects to the water flow computing system 204. In some embodiments, the electronic board can be a part of the water flow computing system 204. Alternatively or additionally, the sensor module 202 can be connected to the water flow computing system 204 through a wireless means, such as via Bluetooth, Near Field Communication (NFC) modules or Wifi components. Electrical signals corresponding to various flow parameters are transmitted by the sensor module 202 to the water flow computing system 204 on a continuous basis. For example, each sensor can provide its own electrical signal to the water flow computing system 204. In some alternate implementations, the signals can be multiplexed and can be provided to the water flow computing system 204. In some still alternate embodiments, the electrical signals can be provided at periodic intervals to the water flow computing system 204, where one type of electrical signal can be provided at a time.

The sensor module 202 may be placed at one or more locations. For example, the volume and time sensor 208 of the sensor module 202 can be installed anywhere before any water accessing devices such as taps, faucets, geysers, showers, etc., along the pipe 203. Preferable locations for placing the pressure sensor 210 of the sensor module 202 may include, a stop-valve. The pressure sensor 210 can be inserted via a T-connector in between a stop-valve and the pipe that goes from that stop-valve to a faucet or any other outlet or water accessing device. In some instances, the vibration and sound sensor 212 of the sensor module 202 can be attached to the outer wall of a water-pipe. It shall be noted that one or more sensor modules 202 may be placed at various locations within or along the pipe 203, and data from each of the sensor modules 202 can be utilized for detection of all water flow related information.

The sensor module 202 senses flow parameters, such as, a flow period (e.g. start of water flow period, end of water flow period.), a flow volume, transient pressure periods and vibration (or sound) associated with the water flowing in the pipe 203. In response to the sensed flow parameters, the sensor module 202 is configured to generate one or more electrical signals at pre-defined intervals, and these electrical signals are received by the water flow computing system 204 on a continuous basis. The electrical signals received from the sensor module 202 are interchangeably referred to as raw data throughout the disclosure.

As an example, volume and time sensor 208 senses the start and end of water flow through a location in the pipe 203 where the volume and time sensor 208 is placed, at pre-defined intervals (say, at interval of 1 second). In some example, the pre-defined intervals may be as low as 100 milliseconds or may be continuous.

Likewise, the pressure sensor 210 constantly measures the pressure in the pipe 203 due to water flow in the pipe. The pressure sensor 210 detects pressure change periods (i.e. transient and static pressure periods) associated with the flow of water in the pipe 203. In a non-limiting example, the pressure sensor 210 can measure a water pressure within a range of 10-100 PSI. The pressure sensor 210 generates electrical signals in response to the measured pressure values, and provides the corresponding electrical signal to the water flow computing system 204. By analyzing such pressure periods, the water flow computing system 204 detects the start, ongoing and end of water flow periods.

Similarly, the electrical signal generated at the vibration and sound sensor 212 is analyzed by the water flow computing system 204 by searching for a pre-defined frequency pattern, which are significant for water flow in pipes. The water flow computing system 204 determines the flow period using the electrical signal received from this vibration and sound sensor 212. In a non-limiting example, the vibration and sound sensor 212 is configured to measure vibrations or sound in the range of 20-5,000 Hz.

The water flow computing system 204 includes a memory and a processor (shown in FIG. 11). The memory stores instructions and one or more files for storing entries corresponding to the raw data. The water flow computing system 204 further includes one or more modules such as a data acquisition and storage module 218 and a water flow related information generation module 220 for processing the raw data. The water flow computing system 204, as an example, includes circuitries such as amplifiers, filters, analog to digital converter (ADC) and a notification module, among others. Alternatively, the amplifier, the filter, and the ADC can be parts of the sensor module 202.

The processor executes instructions stored in the memory to cause the system 204 to receive the raw data transmitted by the sensor module 202 on a continuous basis. The raw data is converted into sensor data by passing the raw data through the amplifier, filter and ADC. Sensor data is the digital values of the raw data that is in form of analog signals. Alternatively, the raw data from the sensor module 202 is provided to a digital input port for generating the sensor data (digital data). The sensor data is stored in a file in the form of entries. Each entry of the sensor data is then appended with an identifier (ID) and validated by discarding erroneous values. The validated entries of the sensor data are then time-stamped. The time-stamped data is recorded in a standardized record which is written into a file stored in the memory for long term storage and future reference. Based on analyzing the sensor data, various types of information such as leakage information and other flow related information such as no-flow, excessive flow, etc., can be obtained.

The data acquisition and storage module 218 and the water flow related information generation module 220 of the water flow computing system 204 may operate in conjunction to account the start and end of all water-flow periods. Records of such flow periods are stored in detail (as sensor data). From the records, the durations of the water-flow periods are calculated, which thereby enables detection of unusual water flows at any particular period (minutes or hours) of a day, or a particular period (hours or days) of a week or a month, etc. The water flow computing system 204 enables the detection of lengthy water-flows and unusual water-flows (or no flow, low flow, high flow) for any time of a day (e.g. 1 hour, between 8:00 a.m.-9:00 a.m.) by comparing the recorded flow periods against predefined thresholds defined for that particular time of the day.

The water flow computing system 204 can be present either in the house or at the house line 203 where the sensor module 202 is located. In one embodiment, the water flow computing system 204 is a local server that gives access to all stored data (sensor data and raw data). In another embodiment, the water flow computing system 204 and the user device 206 or any other device can be connected locally. In yet another embodiment, the user device 206 or any other device can be connected to the water flow computing system 204 via internet or any other means. In still another embodiment, the water flow computing system 204 can be in operative communication with a remote server 216. In such a scenario, the sensor data can be accessed by the user device 206 from the remote server 216. Examples of the remote server 216 include, but are not limited to, a server or device or user device connected via a network other than the LAN.

Examples of the user device 206 includes, but are not limited to, a personal computer (PC), a tablet device, a personal digital assistant (PDA), a smart phone and a laptop. The user device 206 is any in-house or a client device associated with a user.

The user device 206, the water flow computing system 204 and the remote server 216 can communicate among themselves through a communication network 214. The communication network 214 represents any distributed communication network (wired, wireless or combination of wired and wireless networks) for data transmission and receipt between/among two or more points. The communication network 214 may as an example, include standard and/or cellular telephone lines, LAN or WAN links, broadband connections (ISDN, Frame Relay, ATM), wireless links, and so on. Preferably, the communication network 214 can carry TCP/IP protocol communications, and HTTP/HTTPS requests made by the user device 206 and the water flow computing system 204 can be communicated over such communication networks 214. In some implementations, the communication network 214 includes various cellular data networks such as 2G, 3G, 4G, and others. The type of communication network 214 is not limited, and the communication network 214 may include any suitable form of communication. Typical examples of the communication network 214 includes a wireless or wired Ethernet-based intranet, a local or wide-area network (LAN or WAN), and/or the global communications network known as the Internet, which may accommodate many different communications media and protocols.

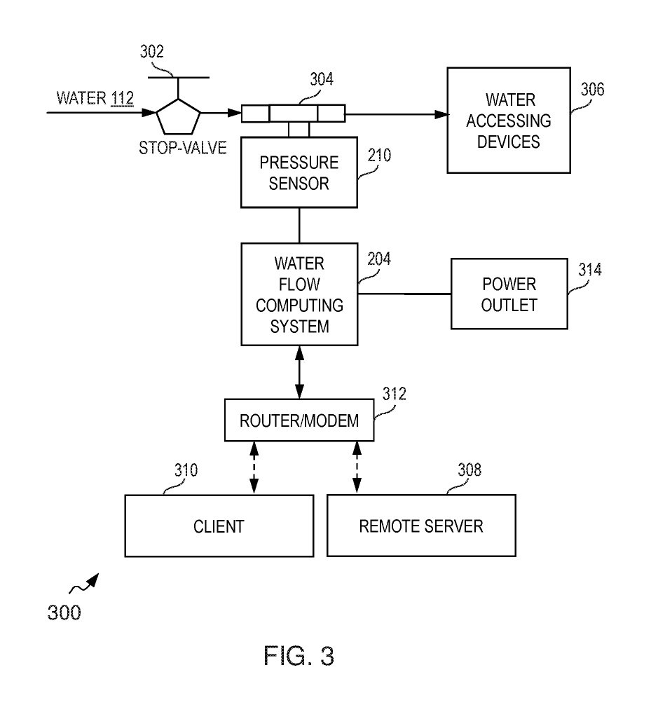

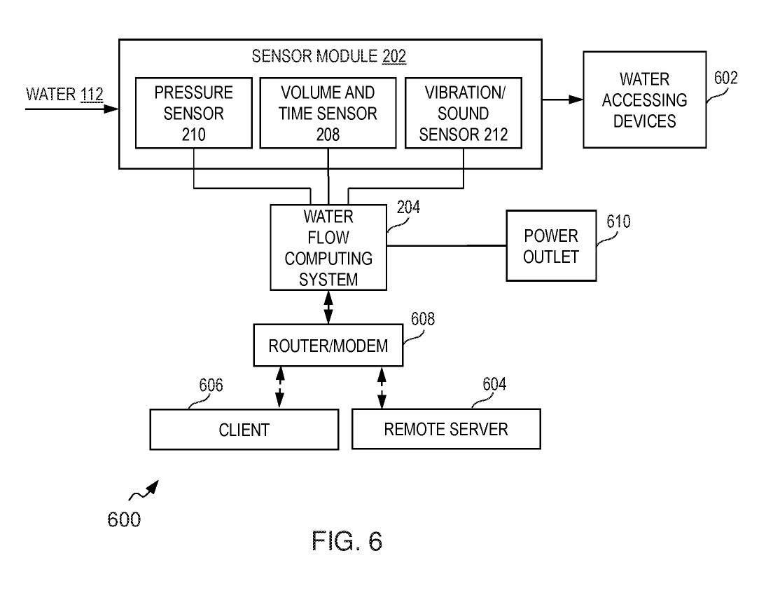

In one embodiment, electrical signals from at least one sensor (208 or 210 or 212) of the sensor module 202 can be analyzed at the water flow computing system 204 for calculating flow periods and thereby detecting unusual water flow in the pipe 203. In another embodiment, signals from a combination of sensors (208 and 210 and 212) of the sensor module 202 can be analyzed at the water flow computing system 204 for calculating flow periods and thereby detecting unusual water flow in the pipe 203. The description with reference to FIGS. 3-5 discloses implementation of a single sensor of the sensor module 202 for detection of water flow periods, water consumption and thereby determine existence of unusual water flow (e.g., leakage) in the pipe 203. The description with reference to FIG. 6 discloses implementation of combination of sensors for detection of water flow periods, water consumption and thereby determine existence of unusual water flow in the pipe 203.

FIG. 3 illustrates a system 300 implementing the pressure sensor 210 of the sensor module 202 for detecting water flow in a pipe (such as the pipe 203), in accordance with an example embodiment of the present disclosure. The system 300 is an example of the system 200. In FIG. 3, the pressure sensor 210 is installed between a stop or a shut-off valve 302 and a hose or pipe 304 that is coupled to any water accessing device 306 (hereinafter also referred to as the device 306). Additionally, the pressure sensor 210 can be inserted anywhere into the pipe 203 via a T connector. Examples of the device 306 include, but are not limited to, a dish-washer, faucet, tap, shower, geyser, washing machine and the like. The pressure sensor 210 is connected to the water flow computing system 204 via a two or three-string wire. The water flow computing system 204 supplies the pressure sensor 210 with power (i.e. DC power) and constantly receives raw data from the pressure sensor 210. The raw data correspond to pressure change periods (transient) and static pressure periods.

In one embodiment, the water flow computing system 204 processes the raw data (electrical signals), converts the raw data into sensor data and stores the sensor data in a file included in the memory. In another embodiment, the water flow computing system 204 forwards the sensor data to a remote server 308, (e.g., remote server 216) and/or a client 310 (such as the user device 206) via a router/modem 312 (hereinafter collectively referred to as the router 312). The water flow computing system 204 is constantly powered from a power outlet 314 (i.e. AC power outlet) and is coupled to the router 312 by means of a network, such as, Wifi or Ethernet.

In an embodiment, the pressure sensor 210 is a sensor device (e.g., a piezo based sensor) that measures water pressure in a range between 10 PSI and 100 PSI with an operating temperature in a range between 32 Fahrenheit (F) and 100 F as an example, at pre-defined intervals of, say, 300 milliseconds (ms). Raw data (electrical signals pertaining to pressure) are sent to the water flow computing system 204 where the raw data is converted into sensor data and stored in the form of plurality of entries. Each entry of the sensor data is appended with an ID and timestamp and then validated by discarding erroneous values from the entries. In an embodiment, a primary algorithm decides if the measured data (pressure) is from a static pressure period or from a transient period. The water flowing in the pipe 203 can exhibit two kinds of pressure states, static state with no or very small fluctuations, and transient state where the pressure goes from one to another static state. If the measured data (pressure) is from transient period, it is stored in time intervals of seconds or milliseconds, and if the measured data (pressure) is during a static pressure period it is stored in time intervals of 60 seconds, as an example.

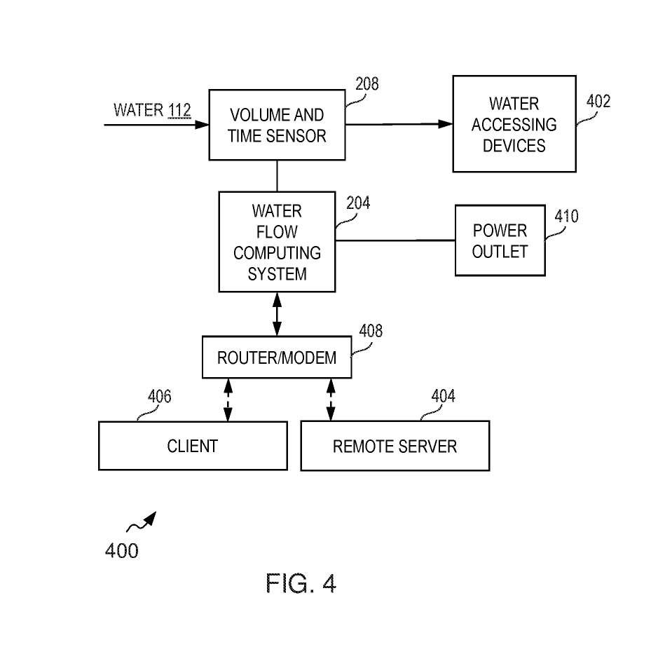

FIG. 4 illustrates a system 400 implementing the volume and time sensor 208 for detecting unusual water flow in a pipe (such as the pipe 203), in accordance with an example embodiment of the present disclosure. The system 400 is an example of the system 200. The volume and time sensor 208 of FIG. 4 must be inserted before all water accessing devices 402. In an example, the volume and time sensor 208 may be inserted in proximity to one or more water accessing devices 402 by severing the house line/pipe 203. The volume and time sensor 208 is connected to the water flow computing system 204 via a two or three-string wire. The water flow computing system 204 supplies electrical power to the volume and time sensor 208. The water flow computing system 204 constantly receives electrical signal from the volume and time sensor 208. The electrical signal corresponds to the start, end and the flow of a volume units of water that passes through the volume and time sensor 208. Exact time and volume records of all flow periods are stored which thereby enables detection of unusual water-flows based on comparison with standard entries/predefined threshold.

In one embodiment, the water flow computing system 204 processes the raw data (electrical signal pertaining to volume and time) and converts the raw data into sensor data. The sensor data is stored in the form of entries in a file. In an embodiment, the water flow computing system 204 sends the sensor data to a remote server 404 (such as the remote servers 308 and/or 216) and/or a client 406 (such as the user device 206) via a router/modem 408 (such as the router/modem 312). The water flow computing system 204 is continuously powered from a power outlet 410 (such as power outlet 314). The water flow computing system 204 is coupled with the router 408 (or modem) by means of a network, such as, Wifi or Ethernet.

The system 400 is configured to detect the exact start and end of any water flow. In this embodiment, the system 400 is also configured to measure the flow-speed of water during the flow period as the water passes through the volume and time sensor 208. The signals are forwarded to the water flow computing system 204. The water flow computing system 204 then adds point of time and calculates flow-speed, volume and duration of flow periods.

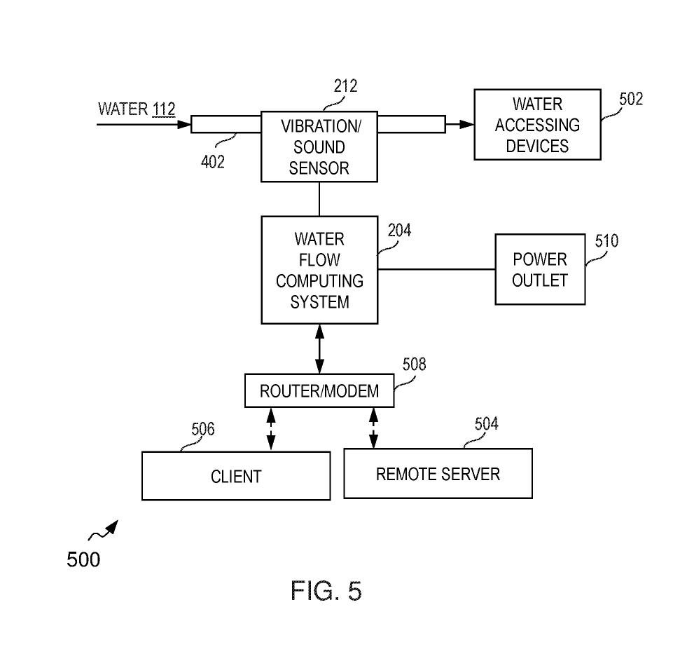

FIG. 5 illustrates a system 500 implementing the vibration and sound sensor 212 for detecting unusual water flow in a pipe (such as the pipe 203), in accordance with an example embodiment of the present disclosure.

The vibration and sound sensor 212 of FIG. 5 is wrapped around a water pipe (such as the pipe 203), where the pipe is easily accessible. For instance, the vibration and sound sensor 212 is wrapped around the inlet pipe of a water accessing device 502 (such as the devices 306 and/or device 402). The vibration and sound sensor 212 is connected to the water flow computing system 204 via a two or three-string wire. The water flow computing system 204 supplies the sensor 212 with power and constantly receives raw data from the sensor 212. In one embodiment, the water flow computing system 204 processes the raw data and generates sensor data and stores the sensor data in a file. In another embodiment, the water flow computing system 204 forwards the sensor data to a remote server 504 (such as remote servers 216, 308 and/or 404) and/or client 506 (such as user device 206) via a router/modem 508 (such as the router/modems 312, 408). The water flow computing system 204 is constantly powered by a power outlet 510 (such as the power outlet 314, 410). The water flow computing system 204 is coupled to the router 508 using a communication network, such as, Wifi or Ethernet.

FIG. 6 illustrates a system 600 implementing the sensor module 202 having a combination of the volume and time sensor 208, the pressure sensor 210 and the vibration and sound sensor 212 for detecting water flow in the pipe 203, in accordance with an example embodiment of the present disclosure. The system 600 is an example of the system 200. The sensors 208, 210 and 212 (i.e. the sensor module 202) of FIG. 6 is placed at one or more locations in the pipe 203 as disclosed in the description with reference to FIGS. 3, 4 and 5. In case of the sensor 208, the location must be before any water accessing device 602. Each of the sensors 208, 210 and 212 is connected to the water flow computing system 204 via a two or three-string wire. The water flow computing system 204 supplies the sensors 208, 210 and 212 with electrical power. The water flow computing system 204 constantly receives electrical signals from each of the sensors 208, 210 and 212. In one embodiment, the water flow computing system 204 processes the raw data (i.e. electrical signals) and converts the raw data into sensor data and stores the sensor data in a file. In another embodiment, the water flow computing system 204 forwards the sensor data to a remote server 604 (such as the remote servers 216, 308, 404 and 504) and/or a client 606 (such as the user device 206) via a router/modem 608 (such as routers/modems 312, 408, 508). The water flow computing system 204 is constantly powered by a power outlet 610 (such as power outlet 314, 410, 510). The water flow computing system 204 is coupled to the router 608 using a communication network, such as, Wi-Fi or Ethernet.

Each of the sensors 208, 210 and 212 is connected to the water flow computing system 204 via a two or three-string wire as explained with reference to FIG. 2. The raw data (electrical signals) from each of the sensors 208, 210 and 212 are amplified, filtered from noise and then sent to a port where the signals are constantly read and transformed to corresponding sensor data (digital data). The sensor data (digital data) is then validated and appended with a time-stamp. In an embodiment, an algorithm decides if the raw data or the corresponding sensor data are based on flow of water or not. For example, the algorithm decides if the electrical signals pertain to water flow period, water flow volume, transient pressure periods associated with water flow, water usage/consumption etc. In a non-limiting example, if the raw data or the corresponding sensor data corresponds to flow of water then the sensor data is stored in intervals of 1 second and if the measured signal is not due to flow of water then the signal is stored every minute. As an example, for the pressure sensor 210, when there is no or little pressure change and the pressure is in a no water flow pressure range then the sensor data is stored in intervals of minutes while during transition periods (pressure change periods) or during flow periods the sensor data is recorded in intervals of seconds. Likewise, for the vibration and sound sensor 212 the electrical signals are searched for pre-defined frequency patterns that are significant for water-flow in different kind of pipes. When such frequency is detected, corresponding sensor data is generated and stored in intervals of seconds. When such frequency is not detected, corresponding sensor data is generated and stored in intervals of minutes.

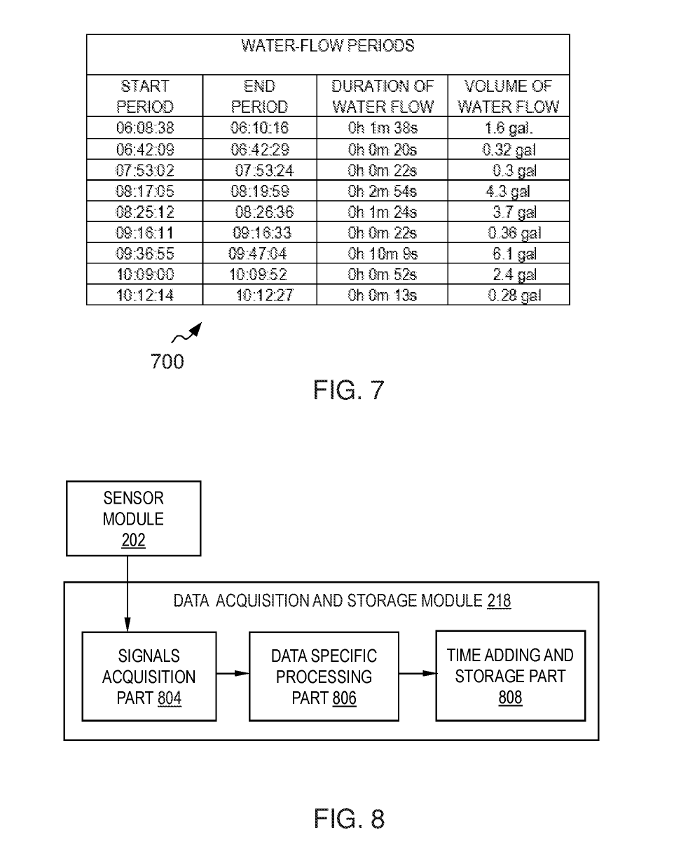

FIG. 7 is an example representation of a table/file 700 of records of water flow periods, in accordance with an example embodiment. In FIG. 7, the flow periods for a duration of approximately four (4) hours (06:08:38-10:12:27) of a day are presented. The data acquisition and storage module 218 accounts the start and the end of all water-flow periods (e.g. 06:08:38-06:10.16, 07:53:02-7:53:24, etc.) in the time between 06:08:38 and 10:12:27. The water flow related information generation module 220 calculates all flow periods (e.g. 1 m 38 seconds, 22 seconds, etc.) based on the start and end of water flow periods. The water flow related information generation module 220 enables detection of unusual water-flows based on the flow periods (lengthy flow periods). As an example, between 06:00 am and 10:00 am, any flow period each lasting a few minutes is usual according to predefined thresholds. Any lengthy flow-period (e.g., 1 hour) in that time period would be considered unusual and immediately a notification will be triggered.

Likewise, volume of water flow during an ongoing flow period may also be used to detect unusual water flow. As an example, between 06:00 am and 10:00 am, a water flow volume of a few dozen gallon (gal) is defined as usual water flow volume according to a predefined threshold. Any volume/capacity of water flow greater than a flow volume of example, 100 gal for that time period (i.e. between 06:00 am and 10:00 am) can be detected as an unusual heavy water flow event.

Predefined thresholds that define usual water flow volume or flow period may be manually defined by a user. The user may define predefined thresholds in terms of flow volume. As an example, a practical manual setting by the user is as follows: for a water-flow periods longer than 30 minutes or greater than 300 gallons, a notification is triggered. Further, the user may define predefined thresholds in terms of a time pattern, i.e. if between 10 pm and 6 am there is a cumulated time of 10 minutes (all flow periods added together) or cumulated 10 gallons then a notification is triggered. The system 200 may further include a machine learning module (not shown) to learn from previous records and define predefined thresholds by itself.

Unusual water flow events include lengthy water-flow, high volume water flow, etc. Unusual water flow events also include no water flow during a time of a day in which water flow should actually exist. Such unusual water flow events can be detected by comparing the flow periods (and/or flow volumes) against pre-defined thresholds. For example, an unusual no flow is detected, when for a particular time, water flow should exist but is not detected in the pipe 203. For example, if between 7 pm and 10 pm a garden watering of about 20 minutes is normal then the non-detection of such a flow period (e.g. 20 minutes) in that time-period (7 pm to 10 pm) triggers a non-alarming notification.

FIG. 8 illustrates the data acquisition and storage module 218, in accordance with an example embodiment of the present disclosure. The data acquisition and storage module 218 is part of the water flow computing system 204. The data acquisition and storage module 218 includes one or more sensors' signals acquisition part 804 that receives electrical signals generated by the sensor module 202 (or any one sensor of the sensor module 202) installed at a user's premise. In some embodiments, the electrical signals coming from the sensor module 202 are first handled based on signal type. The electrical signals, acquired and transmitted by the one or more sensors of the sensor module 202, are passed through an amplifier, filter and ADC. Alternatively, the electrical signals from the one or more sensors is provided to a digital input port for generating digital values for the sensor data. The sensor data is in digital format and stored in the form of a plurality of digital entries along with information of time of receipt of corresponding electrical signal.

The entries of the sensor data are appended with identifiers (ID) and forwarded to a data specific processing part 806. The data specific processing part 806 logically validates the entries coming from the acquisition part 804 by filtering out erroneous values. Herein, erroneous values may correspond to entries having values that should not be considered for computing water flow periods. As an example, erroneous values are caused by weak or unreadable electrical signals due to presence of electrical noise, intense external sound/vibration, e.g. from loud airplanes or heavy truck/machinery passing by or water-pipe internal noise. Further, on the logical data level, erroneous values constitute data which are not of a known length or which may include characters when not desired.

The validated entries (obtained after filtering the erroneous entries) are then forwarded to a time adding and storage part 808. The time adding and storage part 808 adds time-stamp to the validated entries coming from the processing part 806. The time adding and storage part 808 further assembles ID, time and data to a standardized record which is then written into a file included in the memory of the water flow computing system 204 for long term storage.

In another alternate or additional embodiment, the water flow related information generation module 220 can directly calculate flow periods and flow volumes from the sensor data resulting from conversion of the raw data (electrical signals). In this embodiment, the data acquisition and storage module 218 may not store individual sensor data in the file. The water flow related information generation module 220 receives the validated sensor data from the data acquisition and storage module 218 and directly calculates flow periods containing start of flow period, end of flow period, duration of flow period and volume of water flow. The water flow computing system 204 documents/stores a record of the flow periods and the volume of water flow in the file.

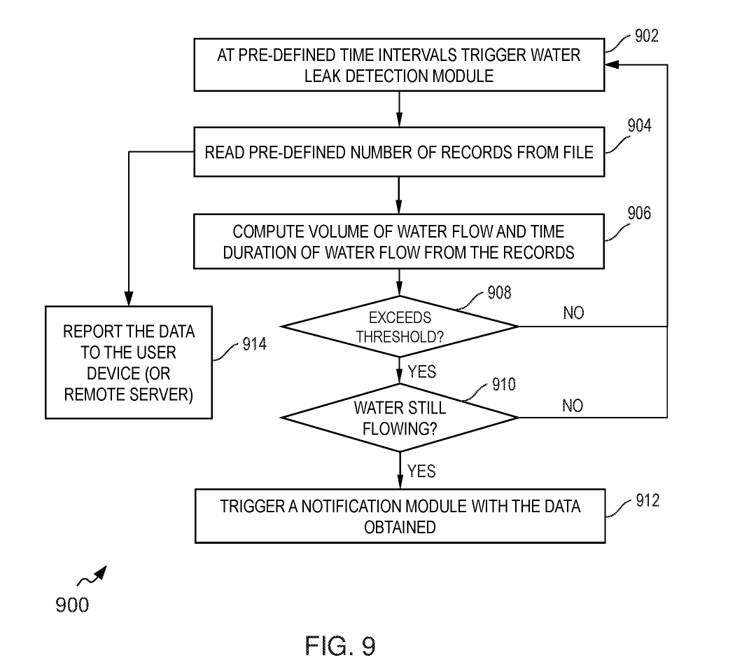

FIG. 9 is a flowchart illustrating a method 900 performed by a water-leak detection module (see, 1104 of FIG. 11) of the water flow computing system 204 or the remote server 216, in accordance with an example embodiment of the present disclosure. The water-leak detection module is an example of the water flow related information generation module 220. The method 900 includes a plurality of steps or operations. The sequence of operations of the method 900 may not be necessarily executed in the same order as they are presented. Further, one or more steps may be grouped together and performed in form of a single step, or one step may have several sub-steps that may be performed in parallel or in sequential manner.

At operation 902, the water-leak detection module is triggered at pre-defined time intervals to retrieve records from a file. The file is stored at a database where the time adding and storage part 808 stores the standardized record corresponding to the sensor data. The file is a part of the memory of the water flow computing system 204. At operation 904, the water-leak detection module is configured to read a pre-defined number of recent records from the file. For example, the water-leak detection module reads recent 500 records from the file every five minutes.

At operation 906, the water-leak detection module is configured to compute volume of water flow and time duration of water flow. At operation 908, the water-leak detection module is configured to perform a check if the volume of water flow or the time duration of the water flow exceeds a pre-defined threshold value or a set of standard entries of sensor data pre-recorded in the file. The pre-defined threshold is defined based on a certain number of standard entries of sensor data which are recorded for a pre-defined duration. The standard entries correspond to usual water flow in a pipe in absence of any unusual water flow.

If it is determined that the volume of water flow or the flow period exceeds respective pre-defined thresholds, the water-leak detection module performs a check to determine if there is continuous water flow at operation 910. If it is determined that there is a continuous water flow, a notification/alarm module (1106 in FIG. 11) is triggered at operation 912. Settings are defined at the notification/alarm module to define when, how and whom to notify any event of unusual water flow.

At operation 914, the water-leak detection module reports data to one or more pre-configured devices, such as the user device 206, a client or the remote server 216. In case, the volume or the length of a flow at operation 908 do not exceed respective pre-defined thresholds, then the method 900 moves to operation 902. Similarly, if at operation 910, it is determined that there is no continuous water flow, the method 900 proceeds to operation 902.

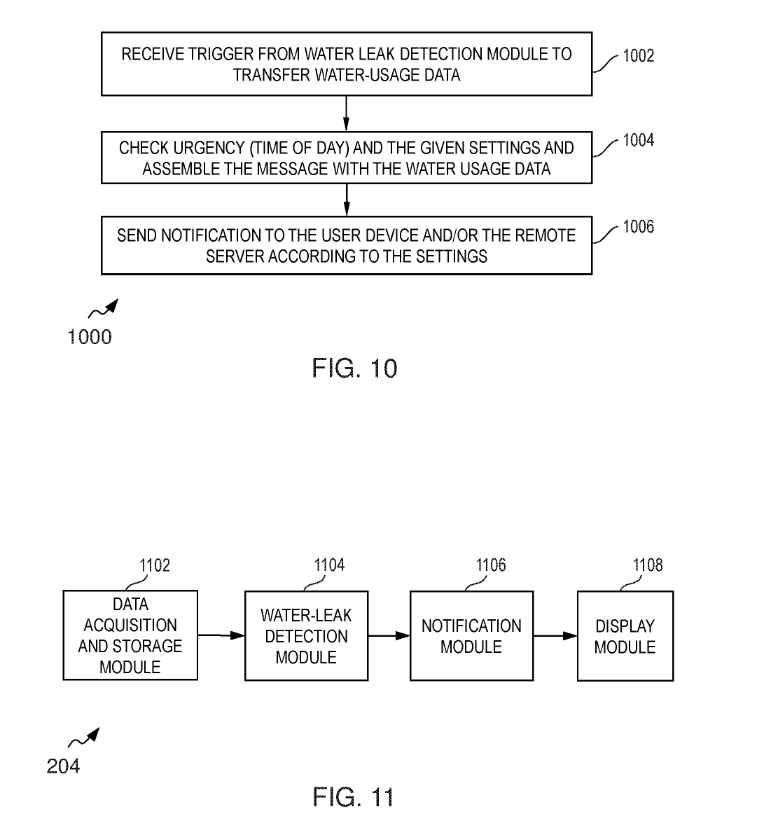

FIG. 10 illustrates a method 1000 performed by a notification module (see 1106 in FIG. 11), in accordance with an example embodiment of the present disclosure. In an embodiment, the method 1000 includes a plurality of steps or operations. The sequence of operations of the method 1000 may not be necessarily executed in the same order as they are presented. Further, one or more steps may be grouped together and performed in form of a single step, or one step may have several sub-steps that may be performed in parallel or in sequential manner.

The notification module is configured with settings defining when, how and who to notify when the notification module gets triggered from the water flow computing system 204. The ‘when’ determines the importance according to intensity and time of day etc. The ‘how’ defines what means of notification, local or remote should be used. The ‘who’ gives the option for telephone-numbers, e-mails, server addresses etc. Based on these settings, notifications are sent to one or more pre-configured devices (e.g., the user device 206, the remote server 216, etc.), at one or more pre-configured time slots (afternoon 12:00 p.m., evening 5:00 p.m.) and to one or more pre-configured contact information (phone numbers of users associated with the user device 206, email addresses of other users, etc.). The notification module also sends sensor data from the file at pre-defined intervals to the client (i.e. the user device 206) and/or the remote server 216.

At operation 1002, the notification module receives trigger from the water flow computing system 204 to transfer water usage data (flow period, flow volume etc.) to the client (the user device 206) and/or the remote server 216. At operation 1004, the notification module checks urgency, time of day and the given settings, and assembles the message with the water usage data. At 1006, notification is sent to the user device 206 or the remote server 216 via audio, video, e-mails, text (SMS) to the client (the user device 206) and/or the remote server 216. Additionally, notification is sent to all set Telephone-Numbers, to all set Server IPs, such as the water supplier server. The notification includes unusual water flow (e.g., leakage information).

FIG. 11 illustrates the modules of a water flow computing system 204, in accordance with an example embodiment of the present disclosure. The system 1100 includes a data acquisition and storage module 1102, which is an example of the module 218 shown in FIG. 1 and explained using FIG. 8, a water leak detection module 1104, which is an example of the module 220 shown in FIG. 1 and explained in reference to FIG. 9, a notification module 1106 explained in reference to FIG. 10, and a display module 1108. The display module 1108 is used to display information associated with water flow/unusual water flow. The modules are implemented using one or more processors.

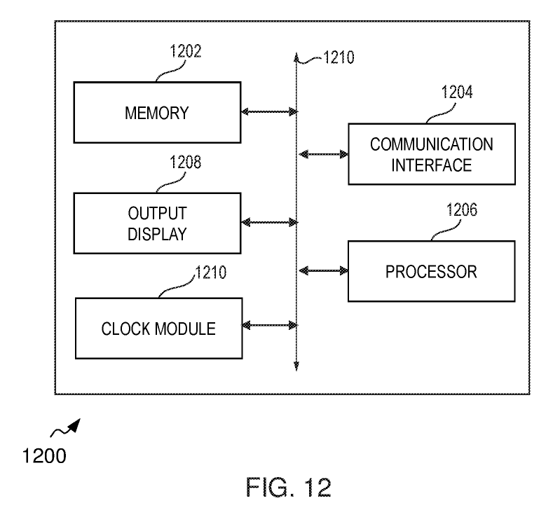

FIG. 12 illustrates a hardware structure of a water flow computing system 1200, which is an example of the water flow computing system 204, in accordance with an example embodiment of the present disclosure. The system 1200 can be implemented as local system or local server or remote server or any other device as described earlier. In an embodiment, the system 1200 includes a memory 1202, a communication interface 1204, at least one processor 1206 and a clock module 1210 for performing sensor related data collection, processing and report generation functionalities.

The memory 1202 is a storage device embodied as one or more volatile memory devices, one or more non-volatile memory devices, and/or a combination of one or more volatile memory devices and non-volatile memory devices, for storing micro-contents information and instructions. The memory 1202 may be embodied as magnetic storage devices (such as hard disk drives, SD cards, SSD, USB-sticks, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The communication interface 1204 may enable the system 1200 to communicate with one or more client devices or user devices.

In an embodiment, the system 1200 is also shown to take an input from an input device, which is directly coupled to the system 1200 or via a network. The system 1200 further shows an output display 1208, such as but not limited to a cathode ray tube (CRT), a LCD screen, a mobile device screen and a laptop screen for displaying information to the user. The communication interface 1204 is capable of communicating with networks including but not limited to, wired, wireless cell phone networks, Wi-Fi networks, terrestrial microwave network, or any form of Internet.

The processor 1206 is communicably coupled with the memory 1202 and the communication interface 1204. The processor 1206 is capable of executing the stored machine executable instructions in the memory 1202 or within the processor 1206 or any storage location accessible to the processor 1206. The processor 1206 may be embodied in a number of different ways. In an embodiment, the processor 1206 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. The processor 1206 performs various functionalities of the system 1200 as described herein. All the components of the system 1200 (such as 1202 to 1208) communicate to each other through a centralized circuit system 1110, which can be an example of printed circuit board (PCB), a motherboard, and/or combination of buses.

The clock module 1210 is an example of a system clock or a real time clock (RTC) that is available in computer systems. Each entry of the sensor data is time-stamped based on the time indicated by the clock module 1210. The clock module 1210, as an example, is an IC present on a circuit board of the water flow computing system 204. The clock module 1210 can further be maintained by the kernel of an operating system and is used to set the tasks and processes, their synchronization and scheduling, settings and managing interrupts, setting timer etc. The clock module 1210 can be updated via a LAN server, Internet time server, and/or GPS system.

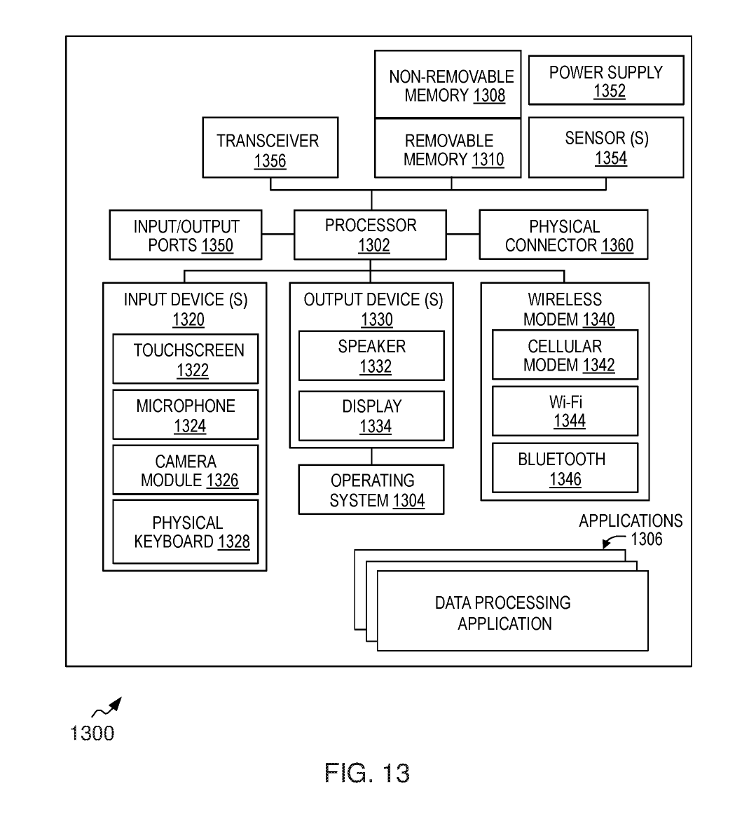

FIG. 13 illustrates a user device 1300 which is an example of the user device or client 206, in accordance with an example embodiment of the present disclosure. In one embodiment, the user device 1300 has the hardware structure as the system 1200 as explained in FIG. 12.

It should be understood that the user device 1300 as illustrated and hereinafter described is merely illustrative of one type of device and should not be taken to limit the scope of the embodiments. As such, it should be appreciated that at least some of the components described below in connection with the user device 1300 may be optional and thus in an example embodiment may include more, less or different components than those described in connection with the example embodiment of the FIG. 13. As such, among other examples, the user device 1300 could be any of a mobile electronic device, for example, personal digital assistants (PDAs), mobile televisions, gaming devices, cellular phones, tablet computers, laptops, mobile computers, cameras, mobile digital assistants, or any combination of the aforementioned, and other types of communication or multimedia devices.

The illustrated user device 1300 includes a controller or a processor 1302 (e.g., a signal processor, microprocessor, ASIC, or other control and processing logic circuitry) for performing such tasks as signal coding, data processing, image processing, input/output processing, power control, and/or other functions. An operating system 1304 controls the allocation and usage of the components of the user device 1300 and support for one or more applications programs that implements one or more of the innovative features described herein.

The illustrated user device 1300 includes one or more memory components, for example, a non-removable memory 1208 and/or removable memory 1310. The non-removable memory 1308 can include RAM, ROM, flash memory, a hard disk, or other well-known memory storage technologies. The removable memory 1310 can include flash memory, smart cards, or a Subscriber Identity Module (SIM). The one or more memory components can be used for storing data and/or code for running the operating system 1304 and the data processing applications 1306. Example of data can include sensed data, text, images, sound files, image data, video data, or other data sets to be sent to and/or received from one or more network servers or other devices via one or more wired or wireless networks.

The user device 1300 can support one or more input devices 1320 and one or more output devices 1330. Examples of the input devices 1320 may include, but are not limited to, a touchscreen 1322 (e.g., capable of capturing finger tap inputs, finger gesture inputs, multi-finger tap inputs, multi-finger gesture inputs, or keystroke inputs from a virtual keyboard or keypad), a microphone 1324 (e.g., capable of capturing voice input), a camera module 1326 (e.g., capable of capturing still picture images and/or video images) and a physical keyboard 1328. Examples of the output devices 1330 may include, but are not limited to a speaker 1332 and a display 1334. Other possible output devices (not shown in the FIG. 13) can include piezoelectric or other haptic output devices. Some devices can serve more than one input/output function. For example, the touchscreen 1322 and the display 1334 can be combined into a single input/output device.

A wireless modem 1340 can be coupled to one or more antennas (not shown in the FIG. 13) and can support two-way communications between the processor 1302 and external devices, as is well understood in the art. The wireless modem 1340 is shown generically and can include, for example, a cellular modem 1342 for communicating at long range with the mobile communication network, a Wi-Fi compatible modem 1344 for communicating at short range with an external Bluetooth-equipped device or a local wireless data network or router, and/or a Bluetooth-compatible modem 1346. The wireless modem 1340 is typically configured for communication with one or more cellular networks, such as a GSM network for data and voice communications within a single cellular network, between cellular networks, or between the user device 1300 and a public switched telephone network (PSTN).

The user device 1300 can further include one or more input/output ports 1350, a power supply 1352, one or more sensors 1354 for example, an accelerometer, a gyroscope, a compass, or an infrared proximity sensor for detecting the orientation or motion of the user device 1300, a transceiver 1356 (for wirelessly transmitting analog or digital signals) and/or a physical connector 1360, which can be a USB port, IEEE 1394 (FireWire) port, and/or RS-232 port. The illustrated components are not required or all-inclusive, as any of the components shown can be deleted and other components can be added.

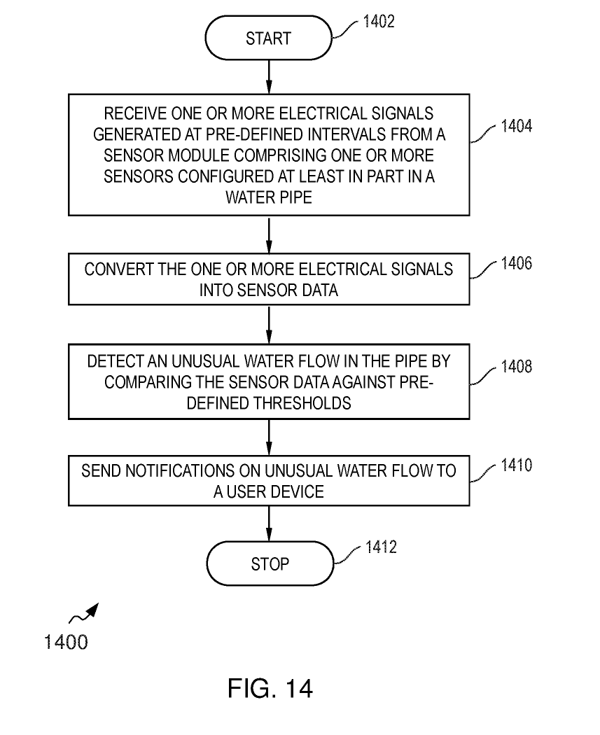

FIG. 14 illustrates a method 1400 for detecting unusual water flow in a pipe, in accordance with an example embodiment of the present disclosure. The method 1400 is performed by the water flow computing systems 204 or 1200, in accordance with an example embodiment of the present disclosure. In an embodiment, the method 1400 includes a plurality of steps or operations. The sequence of operations of the method 1400 may not be necessarily executed in the same order as they are presented. Further, one or more steps may be grouped together and performed in form of a single step, or one step may have several sub-steps that may be performed in parallel or in sequential manner. The method starts at operation 1402.

At step 1404, raw data (electrical signal) is received from one or more sensor of the sensor module 202. The sensor module 202 includes one or more sensors. The sensor module 202 is connected to the water flow computing system 204 (or the system 1200) via a two or three string wire and the sensor module 202 and the water flow computing system 204 (or system 1200) are in operative communication. The raw data is received on a continuous basis from the sensor module 202. The raw data corresponds to flow parameters, such as, a flow period, flow volume, transient pressure periods, etc., associated with water flowing in a pipe such as the pipe 203.

At step 1406, the raw data (electrical signal) is transformed/converted into respective digital values. The raw data is passed through an amplifier, filter and ADC. Alternatively, the raw data from the one or more sensors is provided to a digital input port for generating the digital values. The digital values are stored as the sensor data in form of a plurality of entries, where each entry is appended with an identifier (ID). In an embodiment, erroneous values are discarded from the plurality of entries to obtain the validated entries. The validated entries corresponding to the sensor data are then time-stamped. The time-stamped data is recorded in a standardized record which is written into a file and stored in the memory for long term storage and future reference.

At step 1408, the water flow computing system 204 (or system 1200) detects an unusual water flow in the pipe 203 by comparing the sensor data against pre-defined thresholds. This operation is explained with reference to FIG. 9. The thresholds are defined based on a certain number of standard entries of sensor data which are recorded for a pre-defined duration and which corresponds to usual water flow periods or when no leakage is detected in the house line (such as house line 203).

At step 1410, notification is sent to a user device associated with a user to alert the user of unusual water flow. The water flow computing system 204 (or system 1200) has options such as when, how and who to notify when unusual water flow is detected. Notifications pertain to information associated with unusual water flow. Notifications can be sent at pre-defined/pre-configured times of a day. Notification can be in the form of high intensity alarms, audio messages, video messages, text messages, flash messages, etc. The user device 206 also receives sensor data not pertaining to unusual water flow to be displayed to users at regular intervals. The method stops at operation 1412.

The water flow computing system 204 facilitates a web-application consisting of a client part and a server part. The server part rests in the memory of the water flow computing system 204 or the remote server 216 and the client part can be installed and accessed at the user device 206. The web-application can be run continuously in freely definable intervals or on request. The web-application can be accessed to read any amount of records for any period of time such as the past 24 hours or for a period between 1st of August and 15th of August 2017, etc. The records and information associated with unusual water flow can be displayed in text or graphic mode at the display module (1108 as seen in FIG. 11) and/or at a display/screen of the user device 206. The web-application is open to add as many other displays and reports as required. The server part receives client or user requests for displaying water usage data in a browser when user enters any time period in a format such as, “yy/mm/dd and hh:mm:ss”.

The server part replies to a request sent to the water flow computing system 204 or the remote server 216. The server part reads records for the selected time period and calculates all the individual flow periods during that period by volume and duration with exact start and end. The results are then sent back to the client part. At the client part, there may be many different display and report options from plain text to very advanced graphic for selection by the user.

Various embodiments provide a system that either records the exact time of start and end of every water flow-period sensed and reported by the system 200 or that records the exact time of volume units of water (example gallon, liter etc.) recorded and reported by traditional remote readable volume water-meters. The pressure sensor constantly measures the pressure in the pipe and records the pressure/pressure change together with a time-stamp for imminent or further processing. This provides easy installation between any stop-valve and the fixture, and hence, no pipe-cutting. In addition, it is a very low cost sensor. The vibration and sound sensor, which allows the most easy installation constantly measures the vibration and sounds in the pipe associated with water flow and records of ‘water flow exists’/‘does not exist’ with a time-stamp for imminent or further processing. In various embodiments, the system 200 works by first measuring pressure or vibration/sound events in the pipe (such as the pipe 203).

The sensors are continuously measuring and sensing (and sending) either the pressure or the vibration/sound at their point of connection with the pipe 203 and the water flow computing system 204 for adding time-information and processing and interpreting this data. The results are start, end and duration of water flow-periods and calculated volume of water during the flow period. The measured data includes pressure data or vibration/sound data and/or volume data (pulses, voltage), and exact point of time of each of the above measurement data. The calculated data includes start, end and duration of flow periods, and amount of water volume.

In some embodiments, the pressure regulator is absent and the environment is adaptable so that the environment works without pressure regulator.

In such system, the system 200 includes kernel modules such as the module 1102 that continuously checks the input ports for data from the different sensors. All data received is checked for errors, validated and added with a time-stamp. It is then immediately written as an individual record to a file for long term storage. The module 1104 checks in fixed intervals for unusual long water-flow periods or for unusual high water volume flow. The module 1106 is called in the case it is decided that there might be a water leak. The module 1106 then creates local audio and/or video alarm. The system includes the web application accessing the sensor data remotely. In some embodiments, the module 1106 enables notification of a water leak by text or text-to-speech to one or many telephone numbers or an e-mail to one or many e-mail addresses.

In general, the method executed to implement the embodiments of the present disclosure, may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects of the invention. Moreover, while the present disclosure has been described in the context of fully functioning computers and computer systems, those skilled in the art will appreciate that the various embodiments of the invention are capable of being distributed as a program product in a variety of forms, and that the present disclosure applies equally regardless of the particular type of machine or computer readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 11. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A system for detecting water flow in a pipe, the system comprising:
a sensor module configured at least partially in the pipe, the sensor module comprising one or more sensors, the sensor module configured to generate one or more electrical signals at predefined intervals by sensing one or more flow parameters associated with water in the pipe; and
a water flow computing system in operative communication with the sensor module, the water flow computing system configured to:
receive, on a continuous basis, the one or more electrical signals generated at the predefined intervals from the sensor module;
convert the one or more electrical signals into sensor data corresponding to the one or more flow parameters associated with water passing through the pipe; and
detect an unusual water flow in the pipe by comparing the sensor data against pre-defined thresholds.

2. The system as claimed in claim 1, wherein the one or more flow parameters comprise flow period, flow volume, transient pressure periods of water flow and vibration and sound associated with water flow.

3. The system as claimed in claim 1, wherein the water flow computing system is further configured to:
send a notification to a user device upon detection of the unusual water flow in the pipe; and
facilitate display of information associated with the unusual water flow on the user device.

4. The system as claimed in claim 1, wherein the one or more sensors comprise at least one of:
a volume and time sensor;
a pressure sensor; and
a vibration and sound sensor.

5. The system as claimed in claim 4, wherein the volume and time sensor is configured to:
generate an electrical signal for a volume unit of water that passes through the pipe at a location where the volume and time sensor is placed; and
provide the electrical signal generated for the volume unit of water to the water flow computing system.

6. The system as claimed in claim 4, wherein the vibration and sound sensor is configured to:
generate an electrical signal corresponding to vibration generated in the pipe due to flow of water; and
provide the electrical signal corresponding to vibration generated in the pipe to the water flow computing system.

7. The system as claimed in claim 6, wherein the water flow computing system is further configured to analyse the electrical signal received from the vibration and sound sensor to find a pre-defined frequency pattern in the electrical signal.

8. The system as claimed in claim 4, wherein the pressure sensor is configured to:
measure pressure in the pipe due to water during transient periods of change in pressure in the pipe;
generate electrical signal in response to the measured pressure; and
provide the electrical signal generated in response to the measured pressure to the water flow computing system.

9. The system as claimed in claim 1, wherein the one or more sensors are configured at one or more locations along the pipe.

10. The system as claimed in claim 1, wherein, to convert the one or more electrical signals into sensor data, the water flow computing system is configured to:
convert the one or more electrical signals into respective digital values;
store the digital values as the sensor data in form of a plurality of entries, each entry associated with an identifier (ID) and a time of receipt of corresponding electrical signal of the digital value;
discard erroneous entries from the plurality of entries to obtain validated entries;
add time-stamps to the validated entries; and
store the validated entries of the sensor data comprising IDs of the validated entries and the time-stamps.

11. The system as claimed in claim 10, wherein to detect the unusual water flow in the pipe, the water flow computing system is configured to compare the validated entries of the sensor data against the pre-defined thresholds, wherein the pre-defined thresholds are defined based on standard entries corresponding to the one or more flow parameters, the standard entries recorded during a period associated with a usual water flow in the pipe.

12. The system as claimed in claim 11, wherein the water flow computing system is further configured to:
convert the one or more electrical signals into respective sensor data;
calculate, from the sensor data, flow periods comprising start of flow period, end of flow period, duration of flow period and volumes of water flow; and
store records of the flow periods comprising start of flow period, end of flow period, duration of flow period and the volumes of water flow in a file.

13. The system as claimed in claim 11, wherein the water flow computing system is further configured to send the sensor data for displaying the sensor data to a user device at pre-defined intervals.

14. A water flow computing system for detecting water flow in a pipe, the water flow computing system comprising:
a memory for storing instructions; and
a processor in operative communication with the memory, configured to execute the instructions and cause the water flow computing system to:
receive, on a continuous basis, one or more electrical signals generated at predefined intervals from a sensor module, the sensor module configured to generate the one or more electrical signals by sensing one or more flow parameters associated with water in the pipe;
convert the one or more electrical signals into sensor data corresponding to the one or more flow parameters associated with water passing through the pipe; and
detect an unusual water flow in the pipe by comparing the sensor data against pre-defined thresholds.

15. The water flow computing system as claimed in claim 14, wherein the memory comprises one or more files for storing the sensor data in form of a plurality of entries.

16. The water flow computing system as claimed in claim 15, wherein, to convert the one or more electrical signals into sensor data the water flow computing system is further caused to:
convert the one or more electrical signals into respective digital values;
store the digital values as the sensor data in form of a plurality of entries;
append each entry among the plurality of entries with an identifier (ID);
discard erroneous entries from the plurality of entries to obtain validated entries;
add time-stamps to the validated entries; and
store the validated entries of the sensor data comprising IDs of the validated entries and the time-stamps.

17. The water flow computing system as claimed in claim 15, wherein, to detect an unusual water flow in the pipe the water flow computing system is further caused to:
convert the one or more electrical signals into respective sensor data;
calculate, from the sensor data, flow periods comprising start of flow period, end of flow period, duration of flow period and volumes of water flow; and
store records of the flow periods comprising start of flow period, end of flow period, duration of flow period and the volumes of water flow in a file.

18. A method for detecting water flow in a pipe, the method comprising:
receiving, on a continuous basis, one or more electrical signals generated at predefined intervals from a sensor module comprising one or more sensors configured at least in part in the pipe, the one or more electrical signals corresponding to one or more flow parameters associated with water passing through the pipe;
converting the one or more electrical signals into sensor data corresponding to one or more flow parameters;
detecting an unusual water flow in the pipe by comparing the sensor data against pre-defined thresholds; and
sending notification of the unusual water flow to a user device.

19. The method as claimed in claim 18, wherein converting the one or more signals into sensor data comprises:
converting the one or more electrical signals into respective digital values;
storing the digital values as the sensor data in form of a plurality of entries, each entry associated with an identifier (ID);
discarding erroneous entries from the plurality of entries to obtain validated entries;
adding time-stamps to the validated entries; and
storing the validated entries of the sensor data comprising IDs of the validated entries and the time-stamps.

20. The method as claimed in claim 18, wherein detecting the unusual water flow in the pipe further comprises:
converting the one or more electrical signals into respective sensor data;
calculating, from the sensor data, flow periods comprising start of flow period, end of flow period, duration of flow period and volumes of water flow; and
storing records of the flow periods comprising start of flow period, end of flow period, duration of flow period and the volumes of water flow in a file.

21. The method as claimed in claim 18, wherein detecting the unusual water flow in the pipe further comprises comparing the validated entries against pre-defined thresholds, wherein the pre-defined thresholds are defined based on a number of standard entries.

22. The method as claimed in claim 18, wherein sending notification further comprises sending notifications to one or more pre-configured devices and one or more pre-configured contact information at one or more pre-configured time.
